(19) United States
(12) Patent Application Publication
(10) Pub. No.: US 2008/0166026 A1
(43) Pub. Date: Jul. 10, 2008

(54) Method and apparatus for generating face descriptor using extended local binary patterns, and method and apparatus for face recognition using extended local binary patterns

(75) Inventors: Xiangsheng Huang, Yongin-si (KR); Won-jun Hwang, Seoul (KR); Jiali Zhao, Beijing (CN); Young-su Moon, Seoul (KR); Gyu-tae Park, Anyang-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/882,442

(22) Filed: Aug. 1, 2007

(30) Foreign Application Priority Data
Jan. 10, 2007 (KR) 10-2007-0003068

(51) Int. Cl. G06K 9/00

(52) U.S. Cl. 382/118

(57) ABSTRACT

A face descriptor generating method and apparatus and face recognition method and apparatus using extended local binary pattern (LBP) are provided.

Since LBP features are selected by performing a supervised learning process on the extended LBP features and the selected extended LBP features are used in face recognition, it is possible to reduce errors in face recognition or identity verification and to increase face recognition efficiency. In addition, the extended LBP features are used so that it is possible to overcome the problem of time-consumption of the process.

### CROSS-REFERENCE TO RELATED PATENT APPLICATION

This application claims the benefit of Korean Patent Application No. 10-2007-0003068, filed on Jan. 10, 2007, in the Korean Intellectual Property Office, the disclosure of which is incorporated herein in its entirety by reference.

### BACKGROUND OF THE INVENTION

1. Field of the Invention

The present invention relates to a method and apparatus for generating a face descriptor using a local binary pattern, and a method and apparatus for face recognition using the local binary pattern, and more particularly, to a method and apparatus for face recognition used in biometric systems which automatically recognize or confirm the identity of an individual.

2. Description of the Related Art

Recently, due to the frequent occurrence of terror attacks and theft, security solutions using face recognition have gradually become more important. There is keen interest in implementing biometric solutions to combat terrorist attacks. An efficient way is to strengthen border security and improve identity verification. The International Civil Aviation Organization (ICAO) recommends the use of biometric information in machine-readable travel documents (MRTD). Moreover, the U.S. Enhanced Border Security and Visa Entry Reform Act mandates the use of biometrics in travel documents, passport, and visas, while boosting biometric equipment and software adoption level. Currently, the biometric passport has been adopted in Europe, the USA, Japan, and some other countries. The biometric passport is a novel passport embedded with a chip, which contains biometric information of the user.

Nowadays, many agencies, companies, or other types of organizations require their employees or visitors to use an admission card for the purpose of identity verification. Thus, each person receives a key card or a key pad that is used in a card reader and must be carried at all times while the person is within a designated premise. In this case, however, when a person loses the key card or key pad, or it is stolen, an unauthorized person may access a restricted area and a security problem may thus occur. In order to prevent this situation, biometric systems which automatically recognize or confirm the identity of an individual by using human biometric or behavioral features have been developed. For example, biometric systems have been used in banks, airports, high-security facilities, and so on. Accordingly, much research into easier application and higher reliability of biometric systems has been carried out.

Individual features used in biometric systems include fingerprint, face, palm-print, hand geometry, thermal image, voice, signature, vein shape, typing keystroke dynamics, retina, iris, etc. In particular, face recognition technology is the most widely used identify verification technology. In face recognition technology, images of a person's face, in the form of a still image or a moving picture, are processed by using a face database to verify the identity of the person. Since face image data changes greatly according to pose or illumination, various images of the same person cannot be easily verified as being the same person.

Various image processing methods have been proposed in order to reduce errors in face recognition. These conventional face recognition methods are susceptible to errors caused from assumptions of linear distributions and Gaussian distributions.

In addition, conventionally, since the processing time required to recognize a face is partly used to extract features having limited characteristics from the face images and such features are used in face recognition, face recognition efficiency is low. Moreover, a large change in expression and illumination of a face image may deteriorate the face recognition efficiency.

### SUMMARY OF THE INVENTION

The present invention provides a method and apparatus for face recognition capable of solving problems of high error rate and low recognition efficiency caused by using local binary pattern (LBP) features in face recognition, and reducing the processing time required in face recognition.

According to an aspect of the present invention, there is provided a face descriptor generating method including: (a) extracting extended local binary pattern (LBP) features from a training face image; (b) performing a supervised learning process on the extended LBP features of the training face image for face image classification so as to select the extended LBP features and constructing a LBP feature set based on the selected extended LBP features; (c) applying the constructed LBP feature set to an input face image so as to extract LBP features from the input face image; and (d) generating a face descriptor by using the LBP features of the input face image and the LBP feature set.

According to another aspect of the present invention, there is provided a face descriptor generating apparatus including: a first LBP feature extracting unit which extracts extended local binary pattern (LBP) features from a training face image; a selecting unit which selects the extended LBP features by performing a supervised learning process for face-image-classification on the extracted LBP features and constructs a LBP feature set based on the selected extended LBP; a second LBP feature extracting unit which applies the constructed LBP feature set to an input face image so as to extract LBP features from the input face image; and a face descriptor generating unit which generates a face descriptor by using the LBP features extracted by the second LBP feature extracting unit.

According to another aspect of the present invention, there is provided a face recognition method including: (a) extracting extended local binary pattern (LBP) features from a training face image; (b) performing a supervised learning process on the extended LBP features of the training face image so as to select efficient extended LBP features for face image classification and constructing a LBP feature set based on the selected extended LBP features; (c) applying the constructed LBP feature set to an input face image and a target face image so as to extract LBP features from each of the face images; (d) generating a face descriptor of the input face image and the target face image by using the LBP features extracted in (c) and the LBP feature set; and (e) determining whether or not the generated face descriptors of the input face image and the target face image have a predetermined similarity.

According to another aspect of the present invention, there is provided a face recognition apparatus including: a LBP feature extracting unit which extracts extended local binary pattern (LBP) features from a training face image; a selecting unit which selects the extended LBP features by performing a supervised learning process on the extended LBP features of the training face image and constructs a LBP feature set including the selected LBP features; an input-image LBP feature extracting unit which applies the constructed LBP feature set to an input face image so as to extract LBP features; a target-image LBP feature extracting unit which applies the constructed LBP feature set to a target face image so as to extract LBP features; a face descriptor generating unit which generates face descriptors of the input face image and the target face images by using the LBP features extracted from the input face image, the target face image, and the LBP feature set; and a similarity determining unit which determines whether or not the face descriptors of the input face image and the target face image have a predetermined similarity.

According to another aspect of the present invention, there is provided a computer-readable recording medium having embodied thereon a computer program for executing the face descriptor generating method or the face recognition method in a computer or on the network.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a face descriptor generating apparatus according to an embodiment of the present invention;

FIG. 2 is a diagram illustrating an example of extracting texture information of a local binary pattern (LBP) from 3×3 pixels;

FIG. 3 illustrates an application example of sub-windows suitable for a sub-image region;

FIG. 4 is a flowchart illustrating a face descriptor generating method according to an embodiment of the present invention;

FIG. 5 is a detailed flowchart illustrating an operation of extracting extended LBP features from a training face image as illustrated in FIG. 4 according to an embodiment of the present invention;

FIG. 6 is a flowchart illustrating an example of implantation of extended local binary pattern (LBP) features according to an operation of selecting efficient LBP features as illustrated in FIG. 4 according to an embodiment of the present invention;

FIG. 7 is a detailed flowchart illustrating an operation of selecting efficient LBP features as illustrated in FIG. 4 according to an embodiment of the present invention;

FIG. 8 is a conceptual view illustrating parallel boosting learning in an operation of selecting efficient LBP features as illustrated in FIG. 4 according to an embodiment of the present invention;

FIG. 9 is a detailed flowchart illustrating an operation of selecting LBP feature candidates as illustrated in FIG. 7 according to an embodiment of the present invention;

FIG. 10 is a detailed flowchart illustrating an operation of performing linear discriminant analysis (LDA) as illustrated in FIG. 4 according to an embodiment of the present invention;

FIG. 11 is a detailed flowchart illustrating an operation of selecting at random a kernel center of each of extracted training face images as illustrated in FIG. 10 according to an embodiment of the present invention;

FIG. 12 is a detailed flowchart illustrating an operation of generating LDA basis vectors from feature vectors extracted by LDA learning as illustrated in FIG. 10 according to an embodiment of the present invention;

FIG. 13 is a block diagram illustrating a face recognition apparatus according to an embodiment of the present invention; and

FIG. 14 is a flowchart illustrating a face recognition method according to an embodiment of the present invention.

### DETAILED DESCRIPTION OF THE INVENTION

Hereinafter, the present invention will be described more fully with reference to the accompanying drawings, in which exemplary embodiments of the invention are shown.

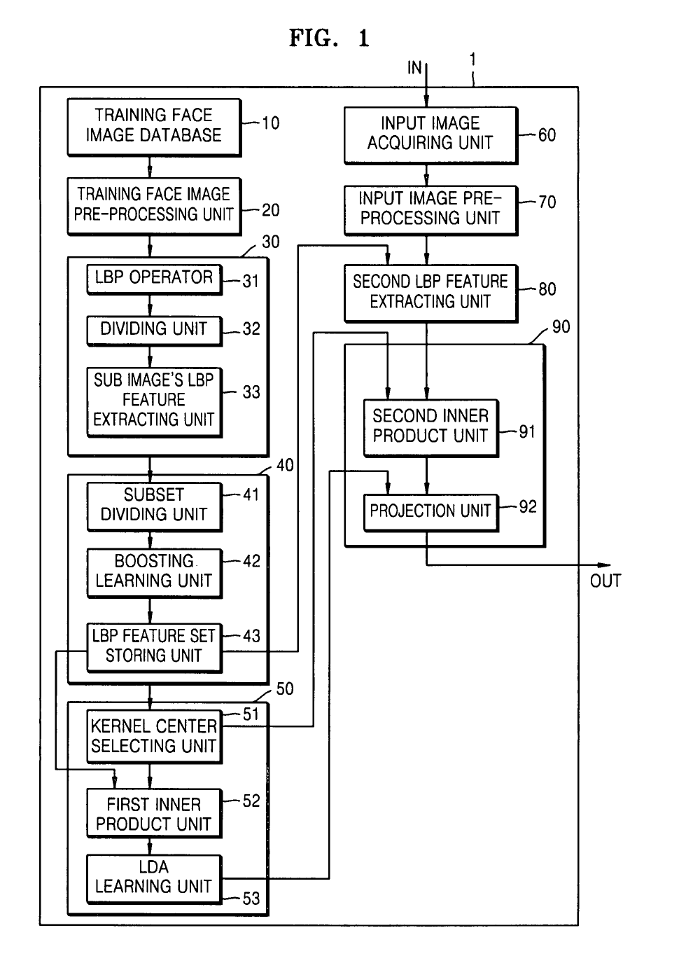

FIG. 1 is a block diagram illustrating a face descriptor generating apparatus according to an embodiment of the present invention. The face descriptor generating apparatus 1 includes a training face image database 10, a training face image pre-processing unit 20, a first extended local binary pattern (LBP) feature extracting unit 30, a selecting unit 40, a basis vector generating unit 50, an input image acquiring unit 60, an input image pre-processing unit 70, a second extended LBP feature extracting unit 80, and a face descriptor generating unit 90.

The training face image database 10 stores face image information of people included in a to-be-identified group. In order to increase face recognition efficiency, face image information of captured images having various expressions, angles, and brightness is needed. The face image information is subject to a predetermined pre-process for generating a face descriptor and, after that, is stored in the training face image database 10.

The training face image pre-processing unit 20 performs a predetermined pre-process on all the face images stored in the training face image database 10. The predetermined pre-process includes transforming the face image to an image suitable for generating the face descriptor through pre-processes of removing background regions from the face image, adjusting a magnitude of the image based on eye location, and reducing a variation in illumination.

The first extended LBP feature extracting unit 30 extracts extended LBP features from each of the pre-processed face images. Here, the term ‘extended LBP features’ means that the conventional LBP features in a limited range are extended in terms of quantity and quality.

The first extended LBP feature extracting unit 30 includes a LBP operator 31, a dividing unit 32, and a sub image's LBP feature extracting unit 33. The LBP operator 31 extracts binary form texture information from the face image. The dividing unit 32 applies sub-windows, which are for dividing regions, to the face image and divides the face image into sub-images. In addition, the dividing unit 32 can divide a two-dimensional image according to texture information of each pixel of the face image into sub-images.

The sub image's LBP feature extracting unit 33 extracts LBP features from the divided face images. The sub image's LBP feature extracting unit 33 divides a histogram according to texture information of the divided sub-images into a plurality of sections and extracts bin features of statistical local texture as extended LBP features.

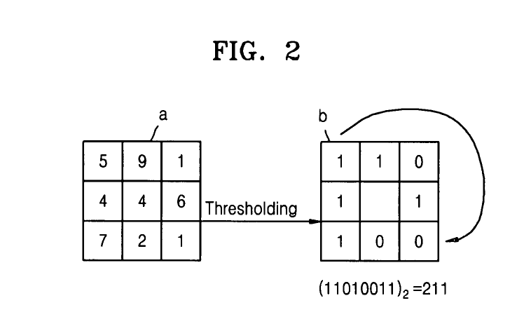

FIG. 2 is a diagram illustrating an example of extracting texture information of a local binary pattern (LBP) from an image with 3×3 pixels. The LBP operator 31 extracts binary form texture information from the image. Image information of a center pixel among information (a) of an image with 3×3 pixels is regarded as a threshold and texture information (b) of the LBP is calculated by comparing sizes of pixels that are close to the center pixel. In the current embodiment, texture information of the LBP can be extended by varying the number of pixels that are sampled according to pixel size. P spots existing in a circle having a radius of R from the center pixel of image information are sampled as texture information of the LBP and can be represented as (P, R). According to the current embodiment, P and R are varied and thus sufficient texture information of the LBP can be obtained.

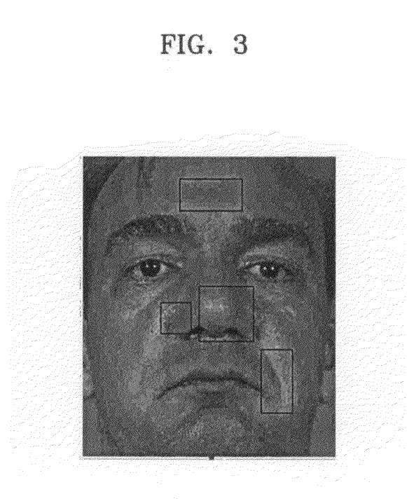

FIG. 3 illustrates an application example of sub-windows suitable for a sub-image region. A square shaped sub-window can be used in a general region. However, a rectangular shaped sub-window having longer sides in right and left directions is suitable for an eye, a forehead, and a mouth region, and a rectangular shaped sub-window having longer sides in top and bottom directions is suitable for a nose and an ear region. According to the current embodiment, sub-windows having various sizes and shapes are used and thus sufficient sub face images can be obtained. One of the methods to obtain sufficient sub face images is to overlap the sub-windows on the face image and to divide the face image into sub face images.

One of the major features of the present invention is extraction of the extended LBP features based on sufficient LBP texture information and sub face images by the sub image's LBP feature extracting unit 33. In addition, since the size of the face image is adjusted or a high-resolution face image is used, the extended LBP features can be extracted.

Since the extended LBP features according to an embodiment of the present invention are extracted based on LBP texture information that is sampled in various ways, and the sub-face images are defined by the sub-windows having various sizes and shapes, the extended LBP features according to an embodiment of the present invention have more sufficient and complementary characteristics than that of the conventional LBP features. In order to distinguish characteristics between the LBP features extracted according to an embodiment of the present invention and the conventional LBP features, the term ‘extended LBP features’ is used in relation to the present invention.

For example, when the sub-windows each having the sizes of 25×30, 30×30, and 30×20 that have a width-step and height-step of 5 pixels overlap the face image having the size of 600×800 pixels and divide the face image, the number of the extracted LBP features can be calculated as follows.

First, the number of the sub face images divided by the sub-window having the size of 25×30 is ((600−25)/5)×((800−30)/5)=17710. The LBP texture information of each sub face image can be represented by one histogram. When the histogram is represented by 59 sections or bins, the total number of the extracted LBP features is 17710×59=1044890. The number of the LBP features extracted by the sub-windows each having the sizes of 30×30 and 30×20 can be calculated by using the same method described above. In this case, the number of the extracted LBP features is 1035804 and 1049256, respectively. Therefore, since 3 sub-windows each having different sizes are applied to one training face image, 3129950 (1044890+1035804+1049256=3129950) features can be extracted as the LBP features. The sub-windows each having different sizes and shapes are more applicable than the sub-windows having one size and shape for extracting more sufficient and complementary LBP features.

Conventionally, a process of generating a face descriptor based on the LBP features extracted from the face image and extended is time-consuming as the complexity of calculation increases.

For this reason, various new learning methods or descriptor generating methods have been proposed in order to increase face recognition efficiency from a limited number of the LBP features, but in order to increase face recognition efficiency, extension for sufficient LBP features has not been attempted.

One of the features that distinguish the face descriptor generating apparatus according to an embodiment of the present invention from the conventional art is an increase in face recognition efficiency through extraction of the face descriptor based on the extended LBP features and overcoming the complexity of calculation by using the selecting unit.

The selecting unit 40 performs a supervised learning process on the extended LBP features so as to select efficient LBP features. In the current embodiment, efficient LBP features are selected by using the selecting unit 40 and thus problems occurring due to the extended LBP features described above are solved. Supervised learning is a learning process having a specific goal such as classification and prediction. In the current embodiment, the selecting unit 40 performs a supervised learning process having a goal of improving efficiency of class classification (person classification) and identity verification. In particular, by using a boosting learning method such as a statistical re-sampling algorithm, the efficient LBP features can be selected. In addition to the boosting learning method, a bagging learning method and a greedy learning method may be used as the statistical re-sampling algorithm.

In the current embodiment, the selecting unit 40 includes a subset dividing unit 41, a boosting learning unit 42, and a LBP feature set storing unit 43. The selecting unit 40 divides the extended LBP features into a predetermined number of subsets. The boosting learning unit 42 performs a parallel boosting learning process on the subset divided LBP features in order to select efficient LBP features. Since the LBP features are selected as a result of a parallel selecting process, the selected LBP features are complementary to each other, so that it is possible to increase the face recognition efficiency. The boosting learning algorithm will be described later. The LBP feature set storing unit 43 stores efficient LBP features selected by the boosting learning unit 42 and selection specification for extracting the selected LBP features as a result of the boosting learning. The selection specification includes location information related to extraction of the LBP features, (P, R) values related to extraction of LBP texture features, and size/shape of the sub-windows.

The basis vector generating unit 50 performs a linear discriminant analysis (LDA) learning process and generates basis vectors. In order to perform the LDA learning process, the basis vector generating unit 50 includes a kernel center selecting unit 51, a first inner product unit 52, and an LDA learning unit 53. The kernel center selecting unit 51 selects at least one training face image from all training face images having selected LBP features as a kernel center. The first inner product unit 52 calculates the inner product of the kernel center with all the training face images so as to generate a new feature vector. The LDA learning unit 53 performs an LDA learning process on the feature vector generated by the first inner product unit 52 and generates a basis vector. The linear discriminant analysis algorithm is described later in detail.

The input image acquiring unit 60 acquires input face images for face recognition. The input image acquiring unit 60 uses an image pickup apparatus (not shown) such as a camera or camcorder capable of capturing the face images of to-be-recognized or to-be-verified people. The input image acquiring unit 60 performs pre-processing on the acquired input image by using the input image pre-processing unit 70.

The input image pre-processing unit 70 removes a background region from the input image acquired by the input image acquiring unit 60, and filters the background-removed face image by using a Gaussian low pass filter. Next, the input image pre-processing unit 70 searches for the location of the eyes in the face image and normalizes the filtered face image based on the location of the eyes. Next, the input image pre-processing unit 70 changes illumination so as to remove variations in illumination.

The second LBP feature extracting unit 80 applies the LBP features set stored in the LBP feature set storing unit 43 to the input face image acquired by the input image acquiring unit 60 so as to extract the LBP features from the input face image. The extracting of the LBP features by applying the LBP features set means that the extended LBP features are extracted from the input face image according to the selection specification of the LBP features set stored as a result of the boosting learning.

The face descriptor generating unit 90 generates a face descriptor by using the LBP features of the input face image. The face descriptor generating unit 90 includes a second inner product unit 91 and a projection unit 92. The inner product unit 91 calculates the inner product of the kernel center selected by the kernel center selecting part 51 with the LBP features extracted from the input face image so as to generate a new feature vector. The projection unit 92 projects the generated feature vector onto a basis vector to generate the face descriptor. The face descriptor generated by the face descriptor generating unit 90 is used to determine a similarity with the face image stored in the training face image database 10 for the purposes of face recognition and identity verification.

Hereinafter, a face descriptor generating method according to an embodiment of the present invention is described in detail with reference to the accompanying drawings.

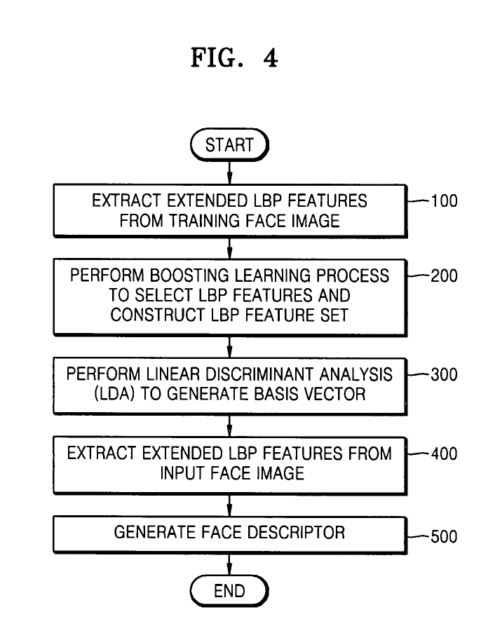

FIG. 4 is a flowchart illustrating a face descriptor generating method according to an embodiment of the present invention. The face descriptor generating method includes operations which are sequentially performed by the aforementioned face descriptor generating apparatus 1.

In operation 100, the first extended LBP feature extracting unit 30 extracts the extended LBP features from a training face image. In the current embodiment, operation 100 further includes pre-processing of the training face image.

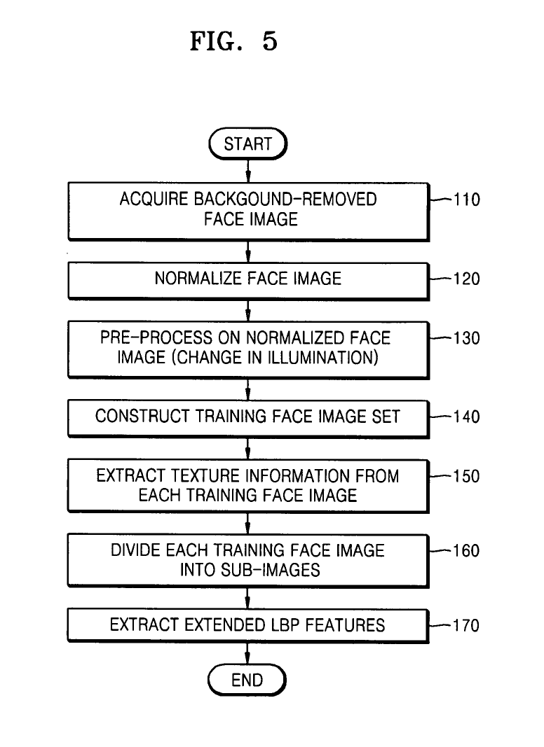

FIG. 5 is a detailed flowchart illustrating operation 100 illustrated in FIG. 4 according to an embodiment of the present invention.

In operation 110, the training face image pre-processing unit 20 removes background regions from each of the training face images. In operation 120, the training face image pre-processing unit 20 normalizes the training face image by adjusting the size of the background-removed training face image based on the location of the eyes. For example, a margin-removed training face image may be normalized with 1000×2000 [pixels]. The training face image pre-processing unit 20 performs filtering of the training face image by using the Gaussian low pass filter to obtain a noise-removed face image. In operation 130, the training face image pre-processing unit 20 performs illumination pre-processing on the normalized face image so as to reduce a variation in illumination. The variation in illumination of the normalized face image causes deterioration in face recognition efficiency, and therefore it is necessary to remove the variation in illumination. For example, a delighting algorithm may be used to remove the variation in illumination of the normalized face image. In operation 140, the training face image pre-processing unit 20 constructs a training face image set which can be used for descriptor generation and face recognition.

In operation 150, the LBP operator 31 extracts texture information from the training face image. In operation 160, the dividing unit 32 divides the training face image into sub-images that each has a different size. In operation 170, the sub image's LBP feature extracting unit 33 extracts the LBP features by using texture information of each divided sub-image.

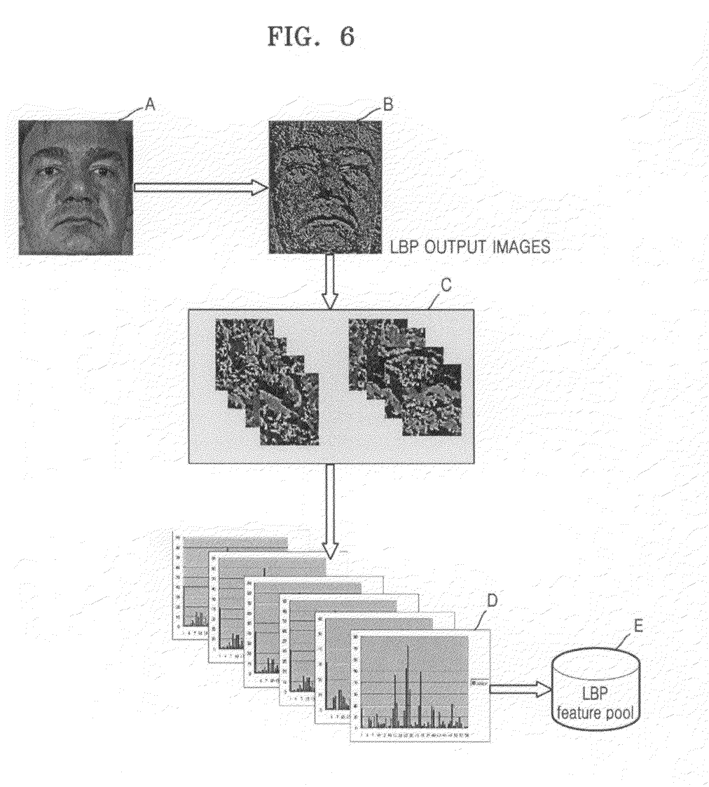

FIG. 6 is a flowchart illustrating an example of implantation of extended LBP features according to operation 200 illustrated in FIG. 4. The LBP operator 31 extracts texture information on the training face image (A). The texture information which is an output value of the LBP operator 31 can be represented as a two-dimensional face image (B). The dividing unit 32 divides the two-dimensional face image (B) into a number of sub-images (C). The sub image's LBP feature extracting unit 33 extracts histograms (D) of each of the sub-image (B) and generates an LBP feature pool (E) comprised of the extracted histogram. The method of constructing the LBP feature pool (E) with the extended LBP features includes controlling a plurality of LBP operators, that is P and R, in an texture information extraction operation 150; and dividing the face image by using the sub-windows each having different sizes and shapes and varying the size of the face image in operation 160.

In operation 200, the selecting unit 40 selects efficient LBP features from the extended LBP features extracted from the first LBP feature extracting unit by using a boosting learning process which is a statistical re-sampling algorithm so as to construct a LBP feature set.

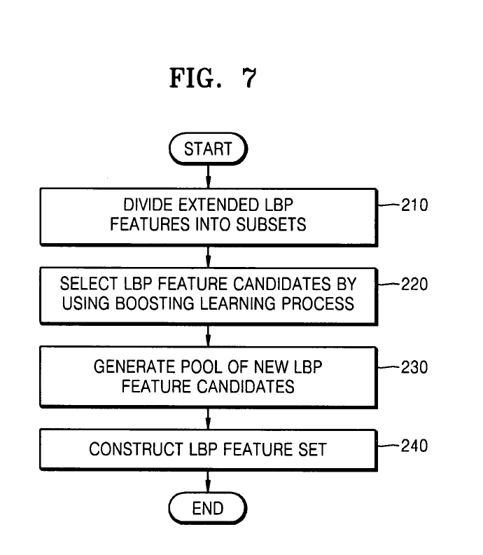

FIG. 7 is a detailed flowchart illustrating operation 200 illustrated in FIG. 4 according to an embodiment of the present invention.

According to the current embodiment, in operation 200, since the LBP features extracted in operation 100 have a large number of the features that reflect sufficient local characteristics, efficient LBP features for face recognition are extracted by using the boosting learning process, so that it is possible to reduce calculation complexity.

In operation 210, the subset dividing part 41 divides the extended LBP features into subsets. For example, as mentioned previously, 3 sub-windows each having different sizes are applied to the training face image having the size of 600×800 pixels so that 3129950 (1044890+1035804+1049256=3129950) extended LBP features can be extracted in operation 100. In addition, as in the same manner, 720036 and 149270 extended LBP features (total number of 399256) can be extracted from the training face images each having the sizes of 300×400 and 150×200 pixels. When the subset dividing unit 41 divides the extended LBP features into 20 subsets, each subset includes 199963 (3999256/20=199963) LBP features.

In operation 220, the boosting learning unit 42 selects LBP feature candidates from the subsets by using the boosting learning process. By using the LBP features of “intra person” and “extra person”, a multi-class face recognition task for multiple people can be transformed into a two-class face recognition task for “intra person” or “extra person”, wherein one class corresponds to one person. Here, the “intra person” denotes a face image group acquired from a specific person, and the “extra person” denotes a face image group acquired from other people excluding the specific person. A difference of values of the LBP features between the “intra person” and the “extra person” can be used as a criterion for classifying the “intra person” and the “extra person”. By combining all the to-be-trained LBP features, intra and extra-personal face image pairs can be generated. Before the boosting learning process, a suitable number of the face image pairs can be selected from the subset and efficient and complementary LBP feature candidates are extracted from the subset.

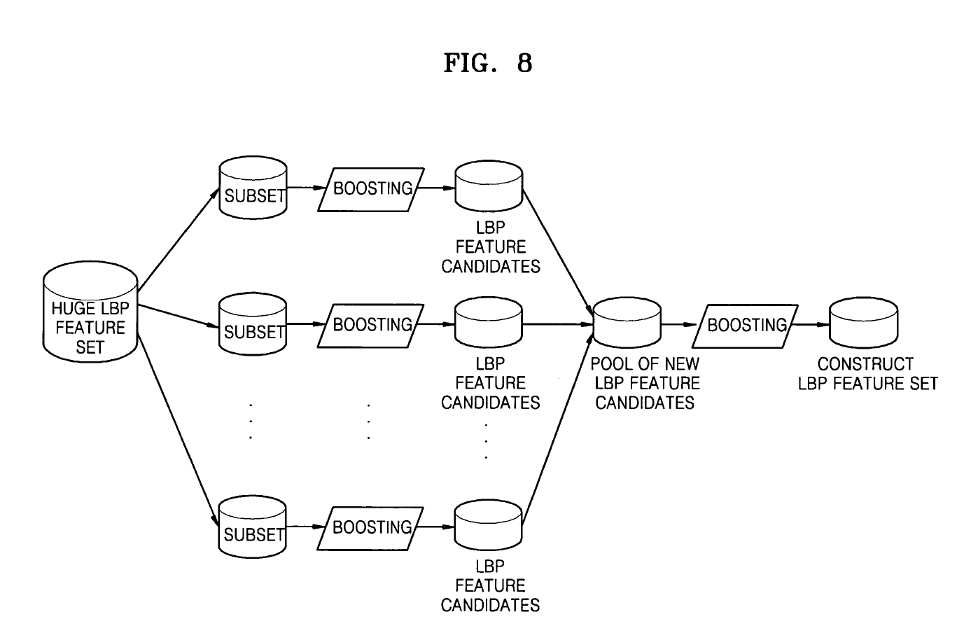

FIG. 8 is a conceptual view illustrating parallel boosting learning in operation 200 illustrated in FIG. 4. In order to select efficient LBP feature candidates for face image recognition, the process of boosting performed on the subsets in parallel is an important mechanism for distributed computing and speedy statistical learning. For example, the boosting learning process is performed on the LBP features of 10,000 intra and extra-person pairs, so that 2,500 intra and extra-person image pairs can be selected as LBP features.

In operation 230, the LBP feature candidates selected from the subsets in operation 220 that satisfy a false acceptance rate (FAR) or a false reject rate (FRR) are collected in order to generate a pool of the new LBP feature candidates. In the embodiment, since the number of subsets is 20, a pool of the new LBP feature candidates including 50,000 intra and extra-personal face image feature pairs can be generated

In operation 240, the boosting learning unit 42 performs the boosting learning process again on the pool of the new LBP feature candidates generated in operation 230 in order to generate a selected LBP feature set that satisfies the FAR or FRR.

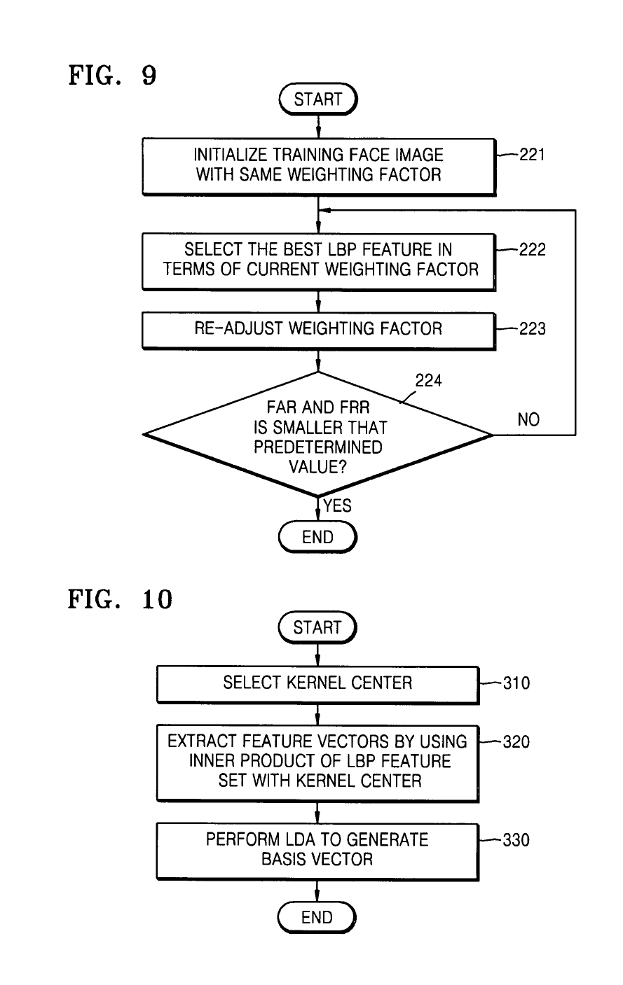

FIG. 9 is a detailed flowchart illustrating the boosting learning process performed in operations 220 and 240 illustrated in FIG. 7 according to an embodiment of the present invention.

In operation 221, the boosting learning unit 42 initializes all the training face images with the same weighting factor before the boosting learning process. In operation 222, the boosting learning unit 42 selects the best LBP feature in terms of a current distribution of the weighting factors. In other words, the LBP features capable of increasing the face recognition efficiency are selected from the LBP features of the subsets. Associated with the face recognition efficiency is a coefficient called a verification ratio (VR). The LBP features may be selected based on the VR. In operation 223, the boosting learning unit 42 re-adjusts the weighting factors of the all the training face images by using the selected LBP features. More specifically, the weighting factors of unclassified samples of the training face images are increased, and the weighting factors of classified samples thereof are decreased. In operation 224, when the selected LBP feature does not satisfy the FAR (for example, 0.0001) and the FRR (for example, 0.01), the boosting learning unit 42 selects another LBP feature based on a current distribution of weighting factors to adjust again the weighting factors of all the training face images. The FAR is a recognition error rate representing how a false person is accepted as the true person, and the FRR is another recognition error rate representing how the true person is rejected as a false person.

There are various boosting learning methods including AdaBoost, GentleBoost, realBoost, KLBoost, and JSBoost learning methods. By selecting complementary LBP features from the subsets by using a boosting learning process, it is possible to increase face recognition efficiency.

FIG. 10 is a detailed flowchart illustrating a process for calculating the basis vector by using the LDA referred to in the description of FIG. 4.

The LDA is a method of extracting a linear combination of variables that can maximize the difference of properties between groups, of investigating the influence of new variables of the linear combination on an array of the groups, and of re-adjusting weighting factors of the variables so as to search for a combination of features capable of most efficiently classifying two or more classes. As an example of the LDA method, there is a kernel LDA learning process and a Fisher LDA method. In the current embodiment, face recognition using the kernel LDA learning process is described.

In operation 310, the kernel center selecting unit 51 selects at random a kernel center of each of the extracted training face images according to the result of the boosting learning process.

In operation 320, the inner product unit 52 calculates the inner product of the LBP feature set with the kernel centers to extract feature vectors. A kernel function for performing an inner product calculation is defined by Equation 1.

$$k ( x , {x}^{′} ) = exp ( - \frac{{‖ x - {x}^{′} ‖}^{2}}{2 {σ}^{2}} ) \qquad [ Equation 1 ]$$

where x′ is one of the kernel centers, and x is one of the training samples. A dimension of new feature vectors of the training samples is equal to a dimension of representative samples.

In operation 330, the LDA learning unit 53 generates LDA basis vectors from the feature vectors extracted through the LDA learning.

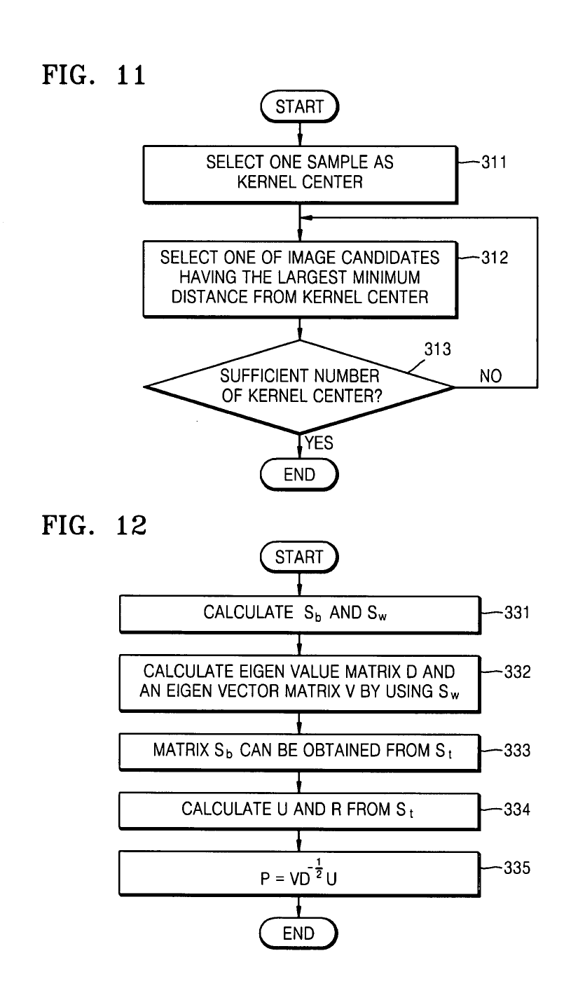

FIG. 11 is a detailed flowchart of operation 310 illustrated in FIG. 10 according to an embodiment of the present invention. An algorithm shown in FIG. 11 is a sequential forward selection algorithm which includes the flowing operations.

In operation 311, the kernel center selecting unit 51 selects at random one sample among all the training face images of one person as a representative sample, that is, the kernel center.

In operation 312, the kernel center selecting unit 51 selects one image candidate from other training face images excluding the kernel center so that the minimum distance between candidate and selected samples is the maximum. The selection of the face image candidates may be defined by Equation 2.

$$c = {max}_{c ∈ S} {min}_{k ∈ K} ( d ( c , k ) ) \qquad [ Equation 2 ]$$

where K denotes the selected representative sample, that is, the kernel center, and S denotes other samples.

In operation 313, the kernel center selecting unit 51 determines whether or not the number of the kernel centers is sufficient. If the number of the kernel centers is not determined to be sufficient in operation 313, the process for selecting another representative sample is repeated until the sufficient number of the kernel centers is obtained. Namely, operations 311 to 313 are repeated. The determination of the sufficient number of the kernel centers may be performed by comparing the VR with a predetermined reference value. For example, 10 kernel centers for one person may be selected, and the training sets for 200 people may be prepared. In this case, about 2,000 representative samples (kernel centers) are obtained, and the dimension of the feature vectors obtained in operation 320 is equal to the dimension of the representative samples, that is, 2,000.

FIG. 12 is a detailed flowchart illustrating operation 330 illustrated in FIG. 10 according to an embodiment of the present invention. In the LDA learning process, data can be linearly projected onto a subspace to reduce within-class scatter and maximize between-class scatter. The LDA basis vector generated in operation 330 represents features of a to-be-recognized group to be efficiently used for face recognition of person of the group. The LDA basis vector can be obtained as follows.

In operation 331, a within-class scatter matrix S_{w} representing within-class variation and a between-class scatter matrix S_{b} representing a between-class variation can be calculated by using all the training samples having a new feature vector. The scatter matrices are defined by Equation 3.

$${S}_{B} = {\sum }_{c = 1}^{C} {{M}_{c} [ {μ}_{c} - μ ] [ {μ}_{c} - μ ]}^{T} \\ {S}_{W} = {\sum }_{c = 1}^{C} {\sum }_{x ∈ {χ}_{c}} {[ x - {μ}_{c} ] [ x - {μ}_{c} ]}^{T} \qquad [ Equation 3 ]$$

where, the training face image set is constructed with C number of classes, x denotes a data vector, that is, a component of the c-th class X_{c}, and the c-th class X_{c} is constructed with M_{c} data vectors. In addition, μ_{c} denotes an average vector of the c-th class, and μ denotes an average vector of the overall training face image set.

In operation 332, scatter matrix S_{w} is decomposed into an eigen value matrix D and an eigen vector matrix V, as shown in Equation 4.

$${D}^{- \frac{1}{2}} {V}^{T} {S}_{w} {VD}^{- \frac{1}{2}} = I \qquad [ Equation 4 ]$$

In operation 333, a matrix Sₜ can be obtained from the between-class scatter matrix S_{b} by using Equation 5.

$${D}^{- \frac{1}{2}} {V}^{T} {S}_{b} {VD}^{- \frac{1}{2}} = {S}_{t} \qquad [ Equation 5 ]$$

In operation 334, the matrix Sₜ is decomposed into an eigen vector matrix U and an eigen value matrix R by using Equation 6.

U^{T}SₜU=R [Equation 6]

In operation 335, basis vector P can be obtained by using Equation 7.

$$P = {VD}^{- \frac{1}{2}} U \qquad [ Equation 7 ]$$

In operation 400, the second LBP feature extracting unit 80 applies the LBP set to the input image to extract extended LBP features from the input image. Operation 500 further includes operations of acquiring the input image and pre-processing the input image. The pre-processing operations are the same as the description mentioned above. The LBP features of the input image can be extracted by applying the LBP feature set selected in operation 200 to the pre-processed input image.

In operation 500, the face descriptor generating unit 90 generates the face descriptor of the input face image by using the LBP feature of the input face image extracted in operation 400 and the basis vectors. The second inner product unit 91 generates a new feature vector by calculating the inner product of the LBP features extracted in operation 400 with the kernel center selected by the kernel center selecting unit 51. The projection unit 92 generates the face descriptor by projecting the new feature vector onto the basis vectors.

Hereinafter, a face recognition apparatus and method according to an embodiment of the present invention are described in detail with reference to the accompanying drawings.

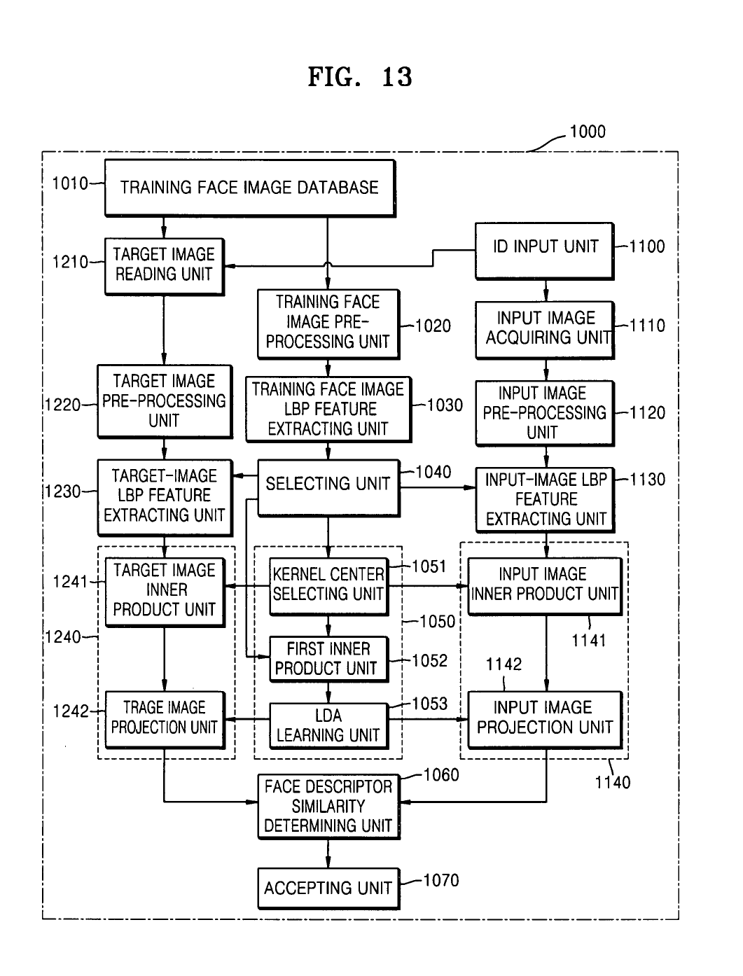

FIG. 13 is a block diagram illustrating a face recognition apparatus 1000 according to an embodiment of the present invention.

The face recognition apparatus 1000 includes a training face image database 1010, a training face image pre-processing unit 1020, a training face image LBP feature extracting unit 1030, a selecting unit 1040, a basis vector generating unit 1050, a similarity determining unit 1060, an accepting unit 1070, an ID input unit 1100, an input image acquiring unit 1110, an input image pre-processing unit 1120, an input-image LBP feature extracting unit 1130, an input-image face descriptor generating unit 1140, a target image reading unit 1210, a target image pre-processing unit 1220, a target-image LBP feature extracting unit 1230, and a target-image face descriptor generating unit 1240.

The components 1010 to 1050 shown in FIG. 13 correspond to the components shown in FIG. 1, and thus detailed descriptions thereof will be omitted here.

The ID input unit 1100 receives ID of a to-be-recognized (or to-be-verified) person.

The input image acquiring unit 1110 acquires a face image of the to-be-recognized person by using an image pickup apparatus such as a digital camera.

The target image reading unit 1210 reads out a face image corresponding to the ID received by the ID input unit 1110 from the training face image database 2010. The image pre-processes performed by the input image pre-processing unit 1120 and the target image pre-processing unit 1220 are the same as the aforementioned image pre-processes.

The input-image LBP feature extracting unit 1130 applies the LBP feature set to the input image in order to extract the LBP features from the input image. The LBP feature set is previously stored in the selecting unit 1040 during the boosting learning process.

The input image inner product unit 1141 calculates the inner product of the LBP features extracted from the input image with the kernel center to generate new feature vectors of the input image. The target image inner product unit 1241 calculates the inner product of the LBP features extracted from the target image with the kernel center in order to generate new feature vectors of the target image feature. The kernel center is previously selected by a kernel center selecting unit 1051.

The input image projection unit 1142 generates a face descriptor of the input image by projecting the feature vectors of the input image onto the basis vectors. The target image projection unit 1242 generates a face descriptor of the target image by projecting the feature vectors of the target image onto the basis vectors. The basis vector is previously generated by an LDA learning process of an LDA learning unit 1053.

The face descriptor similarity determining unit 1060 determines a similarity between the face descriptors of the input image and the target image generated by the input image projection unit 1142 and the target image projection unit 1242. The similarity can be determined based on a cosine distance between the face descriptors. In addition to the cosine distance, Euclidean distance and Mahalanobis distance may be used for face recognition.

If the person inputting their ID is determined to be the same person in the face descriptor similarity determining unit 1050, the accepting unit 1060 accepts the person inputting their ID. If not, the face image may be picked up again, or the person inputting their ID may be rejected.

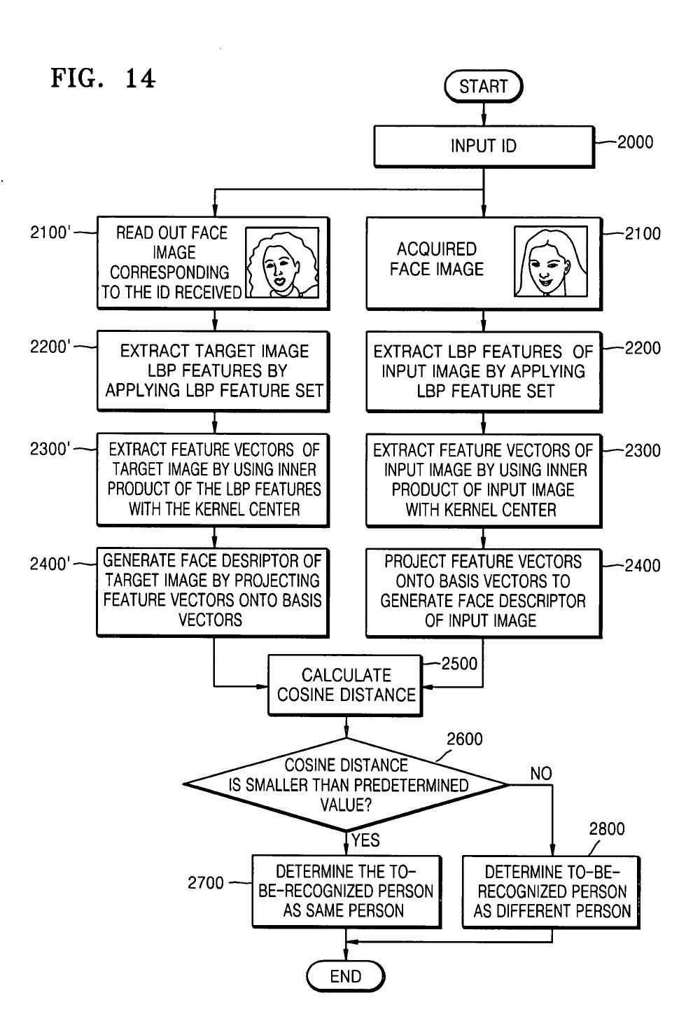

FIG. 14 is a flowchart illustrating a face recognition method according to an embodiment of the present invention. The face recognition method includes operations which are sequentially performed by the face recognition apparatus 1000.

In operation 2000, the ID input unit 1100 receives ID of a to-be-recognized (or to-be-verified) person.

In operation 2100, the input image acquiring unit 1110 acquires a face image of the to-be-recognized person. Operation 2100′ is an operation of reading out the face image corresponding to the ID received in operation 2000 from the training face image database 1010.

In operation 2200, the input-image LBP feature extracting unit 1130 extracts the LBP features from the input face image. Before operation 2200, the pre-processing may have been performed on the face image acquired in operation 2100. In operation 2200, the input-image LBP feature extracting unit 1130 extracts the LBP features from the pre-processed input face image by applying the LBP feature set generated as a result of the boosting learning. In operation 2200′, the target-image LBP feature extracting unit 1230 extracts target-image LBP features by applying the LBP feature set for the face image selected according to the ID and acquired by the pre-process. In the case where the target-image LBP features are previously stored in the training face image database 1010, operation 2200′ is not needed.

In operation 2300, the input image inner product unit 1141 calculates the inner product of the input image having extracted LBP feature information with the kernel center to calculate the feature vectors of the input image. Similarly, in operation 2300′, the target image inner product unit 1241 calculates the inner product of the LBP features of the target image with the kernel center in order to calculate the feature vectors of the target image.

In operation 2400, the input image projection unit 1142 generates a face descriptor of the input image by projecting the feature vectors of the input image calculated in operation 2300 onto the LDA basis vectors. Similarly, the target image projection unit 1242 generates a face descriptor of the target image by projecting the feature vectors of the target image onto the LDA basis vectors.

In operation 2500, a cosine distance calculating unit (not shown) calculates a cosine distance between the face descriptors of the input image and the target image. The cosine distance between the two face descriptors calculated in operation 2500 are used for face reorganization and face verification. In addition to the cosine distance, Euclidean distance and Mahalanobis distance may be used for face recognition.

In operation 2600, if the cosine distance calculated in operation 2500 is smaller than a predetermined value, the similarity determining unit 1060 determines that the to-be-recognized person is the same person as the face image from the training face image database 1010 (operation 2700). If not, the similarity determining unit 1060 determines that the to-be-recognized person is not the same person as the face image from the training face image database 1010 (operation 2800), and the face recognition ends.

The invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

According to the present invention, since the extended LBP features are extracted from the face image, it is possible to reduce errors in face recognition or identity verification and to increase face recognition efficiency. In addition, according to the present invention, only specific features can be selected from the extended LBP features by performing a supervised learning process, so that it is possible to overcome the problem of time-consumption of the process. Moreover, according to the present invention, a parallel boosting learning process is performed on the extended LBP features to select complementary LBP features, thereby increasing face recognition efficiency.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A face descriptor generating method comprising:
(a) extracting extended local binary pattern (LBP) features from a training face image;
(b) performing a supervised learning process on the extended LBP features of the training face image for face image classification so as to select the extended LBP features and constructing a LBP feature set based on the selected extended LBP features;
(c) applying the constructed LBP feature set to an input face image so as to extract LBP features from the input face image; and
(d) generating a face descriptor by using the LBP features of the input face image and the LBP feature set.

2. The face descriptor generating method of claim 1, wherein the extended LBP features in (a) are extracted from a plurality of sub-images that are divided from the training face image.

3. The face descriptor generating method of claim 2, wherein the sub-images each have different resolution, size, location, and shape.

4. The face descriptor generating method of claim 2, wherein the sub-images at least overlap in some parts.

5. The face descriptor generating method of claim 1, wherein (a) comprises;
(a1) extracting texture information from the training face image;
(a2) dividing the training face image into a plurality of sub-images by using a sub-window having a predetermined size and shape; and
(a3) extracting the extended LBP features by using texture information of the sub-images.

6. The face descriptor generating method of claim 1, wherein (d) comprises:
(d1) performing a linear discriminant analysis (LDA) learning process by using the constructed LBP feature set to generate basis vectors; and
(d2) generating the face descriptor by using the LBP features of the input face image extracted in (c) and the generated basis vectors.

7. The face descriptor generating method of claim 1, wherein (b) further comprises dividing the extended LBP features into subsets, and wherein the performing of the supervised learning process is embodied by performing a parallel boosting learning process on the divided subsets.

8. The face descriptor generating method of claim 1, further comprises a pre-processing operation comprising:
filtering the training face image by using a Gaussian low pass filter;
searching for the location of eyes in the filtered training face image;
normalizing the filtered face image based on the location of the eyes; and
changing illumination to remove a variation in illumination.

9. The face descriptor generating method of claim 1, wherein (b) comprises:
(b1) dividing the extended LBP features extracted in (a) into subsets;
(b2) performing a parallel boosting learning process on the divided subsets to select LBP feature candidates for lowering an FAR (false accept rate) or an FRR (false reject rate) below a first standard value;
(b3) collecting the LBP feature candidates selected from the subsets to generate a LBP feature pool; and
(b4) performing the parallel boosting learning process on the generated LBP feature pool in order to construct the LBP feature set for lowering the FAR or the FRR below a second standard value.

10. The face descriptor generating method of claim 6, wherein (d1) comprises:
(d11) selecting at least one training face image as a kernel center from all the training face images having the LBP features extracted from the LBP feature set;
(d12) generating feature vectors by calculating the inner product of all the training face images having the extracted LBP features with the kernel center; and
(d13) performing a linear discriminant analysis learning process on the feature vectors generated in (d12) so as to generate basis vectors.

11. The face descriptor generating method of claim 10, wherein (d13) comprises generating the basis vectors by using a between-class scatter matrix and a within-class scatter matrix.

12. The face descriptor generating method of claim 10, wherein (d2) comprises:
(d21) calculating the inner product of the input face image having the LBP features extracted in (c) with the kernel center selected in (d11) in order to generate the feature vectors of the input face image; and
(d22) projecting the feature vectors of the input face image onto the basis vectors generated in (d13) in order to generate the face descriptor of the input face image.

13. A computer-readable recording medium having embodied thereon a computer program for executing the face descriptor generating method of claim 1.

14. A face recognition method comprising:
(a) extracting extended local binary pattern (LBP) features from a training face image;
(b) performing a supervised learning process on the extended LBP features of the training face image so as to select efficient extended LBP features for face image classification and constructing a LBP feature set based on the selected extended LBP features;
(c) applying the constructed LBP feature set to an input face image and a target face image so as to extract LBP features from each of the face images;
(d) generating a face descriptor of the input face image and the target face image by using the LBP features extracted in (c) and the LBP feature set; and
(e) determining whether or not the generated face descriptors of the input face image and the target face image have a predetermined similarity.

15. The face recognition method of claim 14, wherein the extended LBP features in (a) are extracted from a plurality of sub-images that are divided from the training face image.

16. The face recognition method of claim 14, wherein (d) comprises:
(d1) performing a linear discriminant analysis (LDA) learning process by using the constructed LBP feature set to generate basis vectors; and
(d2) generating the face descriptor by using the LBP features of the input face image extracted in (c) and the generated basis vectors.

17. The face recognition method of claim 14, wherein (b) further comprises dividing the extended LBP features into subsets, and wherein the performing of the supervised learning process is embodied by performing a parallel boosting learning process on the divided subsets.

18. A computer-readable recording medium having embodied thereon a computer program for executing the face descriptor generating method of claim 14.

19. A face descriptor generating apparatus comprising:
a first LBP feature extracting unit which extracts extended local binary pattern (LBP) features from a training face image;
a selecting unit which selects the extended LBP features by performing a supervised learning process for face-image-classification on the extracted LBP features and constructs a LBP feature set based on the selected extended LBP;
a second LBP feature extracting unit which applies the constructed LBP feature set to an input face image so as to extract LBP features from the input face image; and
a face descriptor generating unit which generates a face descriptor by using the LBP features extracted by the second LBP feature extracting unit.

20. The face descriptor generating apparatus of claim 19, further comprising a basis vector generating unit which generates basis vectors by performing a linear discriminant analysis (LDA) learning process on the constructed LBP feature set,
wherein the face descriptor generating unit generates the face descriptor by using the LBP features extracted by the second LBP feature extracting unit and the basis vectors.

21. The face descriptor generating apparatus of claim 19, wherein the selecting unit comprises:
a subset dividing unit which divides the LBP features extracted by the first LBP feature extracting unit into subsets; and
a learning unit which performs a parallel boosting learning process on the divided subsets so as to select efficient LBP features for face-image-classification.

22. A face recognition apparatus comprising:
a LBP feature extracting unit which extracts extended local binary pattern (LBP) features from a training face image;
a selecting unit which selects the extended LBP features by performing a supervised learning process on the extended LBP features of the training face image and constructs a LBP feature set including the selected LBP features;
an input-image LBP feature extracting unit which applies the constructed LBP feature set to an input face image so as to extract LBP features;
a target-image LBP feature extracting unit which applies the constructed LBP feature set to a target face image so as to extract LBP features;
a face descriptor generating unit which generates face descriptors of the input face image and the target face images by using the LBP features extracted from the input face image, the target face image, and the LBP feature set; and
a similarity determining unit which determines whether or not the face descriptors of the input face image and the target face image have a predetermined similarity.
